(19) United States
(12) Patent Application Publication
(10) Pub. No.: US 2020/0351932 A1
(43) Pub. Date: Nov. 5, 2020

(54) METHOD FOR UPLINK DATA TRANSMISSION AND USER EQUIPMENT AND BASE STATION USING THE SAME

(71) Applicant: Industrial Technology Research Institute, Hsinchu (TW)

(72) Inventors: Tzu-Jane Tsai, Hsinchu County (TW); Chun-Yuan Chiu, Pingtung County (TW); Wan-Jung Tsai, Taoyuan City (TW)

(73) Assignee: Industrial Technology Research Institute, Hsinchu (TW)

(21) Appl. No.: 16/862,574

(22) Filed: Apr. 30, 2020

Related U.S. Application Data
(60) Provisional application No. 62/842,543, filed on May 3, 2019.

(51) Int. Cl. H04W 72/14; H04W 72/12; H04L 1/00

(52) U.S. Cl. CPC H04W 72/14; H04L 1/0003; H04L 1/0009; H04W 72/1268

(57) ABSTRACT

A method for an uplink data transmission and user equipment (UE) and a base station using the same are provided. The method for the UE includes: receiving a first message to obtain a dynamic grant; using the dynamic grant to upload a first type data according to the first message; receiving a second message to obtain a configured grant; using the configured grant to upload a second type data according to the second message; cancelling the first type data uploading if the first type data uploading and the second type data uploading are partially or fully overlapping in time and a first priority of the dynamic grant is lower than a second priority of the configured grant; and determining whether to resume the first type data uploading after the end of the second type data uploading.

### CROSS-REFERENCE TO RELATED APPLICATION

This application claims the priority benefit of U.S. provisional application Ser. No. 62/842,543, filed on May 3, 2019. The entirety of the above-mentioned patent application is hereby incorporated by reference herein and made a part of this specification.

### TECHNICAL FIELD

The disclosure provides a method for uplink data transmission and user equipment and a base station using the same.

### BACKGROUND

With the popularization of the Internet of things (IoT) technology, more and more users try to apply user equipment (UE) that supports the IoT technology to the industrial field. For example, an unmanned aerial vehicle (UAV) that supports the industrial IoT technology can be used to monitor equipment or personnel in a smart factory in real time. Devices (such as the UAV) that support the industrial IoT can perform transmission of two types of data, such as enhanced mobile broadband (eMBB) and ultra-reliable and low latency communications (URLLC). The eMBB traffic can be used to transmit data associated with images, and the URLLC traffic can be used to transmit data associated with motion control. Generally speaking, the eMBB traffic tends to be sustained, while the URLLC traffic tends to be sporadic and unpredictable.

FIG. 1 illustrates a schematic diagram of transmitting an eMBB data and a URLLC data by UE. Assuming that the UE has received a configured grant of the URLLC data, the UE may allocate resources for uploading the URLLC data according to the configured grant. For example, the UE may pre-allocate a periodic resource 11 as a resource for uploading the URLLC data. Assuming that the UE receives a dynamic grant of the eMBB data, the UE may allocate resources for uploading the eMBB data according to the dynamic grant. For example, the UE may allocate a resource 12 as a resource for uploading the eMBB data. According to the description of 3GPP Release 15, if the resources for uploading the URLLC data and the resources for uploading the eMBB data overlap in time, that is, when a resources conflict occurs between the dynamic grant of the eMBB data and the configured grant of the URLLC data, the dynamic grant always overrides the configured grant.

For example, it is assumed that the UE receives the dynamic grant at a time point T1 to instruct the UE to start transmitting the eMBB data at a time point T3, and receives a notification message at a time point T2 to instruct the UE to start transmitting the URLLC data. The UE may select the resource 11 closest to the time point T2 and corresponding to a time point T4 to transmit the URLLC data after receiving the notification message. If the resource 11 corresponding to the time point T4 and the resource 12 overlap in time, since the dynamic grant always overrides the configured grant, the UE will drop the URLLC data needing to be transmitted at the time point T4 and transmit the eMBB data at the time point T3.

On the other hand, according to the description of 3GPP Release 16, the UE may determine data to be transmitted by it and data to be dropped by it according to the priorities of the dynamic grant and the configured grant. For example, it is assumed that the UE receives the dynamic grant at the time point T1 to instruct the UE to start transmitting the eMBB data at the time point T3, and receives the notification message at the time point T2 to instruct the UE to start transmitting the URLLC data. Furthermore, the priority of the dynamic grant corresponding to the eMBB data is lower than the priority of the configured grant corresponding to the URLLC data. The UE may select the resource 11 closest to the time point T2 and corresponding to a time point T4 to transmit the URLLC data after receiving the notification message. If the resource 11 corresponding to the time point T4 and the resource 12 overlap in time, the UE will drop the eMBB data needing to be transmitted and transmit the URLLC data at the time point T4 according to the priorities.

However, in some cases, it may not be desirable to drop the eMBB data. For example, the resource efficiency would degrade if the eMBB uploading has lasted for a period of time and cancelled at the time point T4.

### SUMMARY

The disclosure provides a method for uplink data transmission and UE and a base station using the same. The method may assist the UE in selecting an appropriate scheme to transmit uplink data when a conflict occurs in uplink resources of two types of data.

A method for uplink data transmission of the disclosure is suitable for UE. The method includes: receiving a first message to obtain a dynamic grant; using the dynamic grant to upload a first type data according to the first message; receiving a second message to obtain a configured grant; using the configured grant to upload a second type data according to the second message; cancelling the first type data uploading if the first type data uploading and the second type data uploading are partially or fully overlapping in time and a first priority of the dynamic grant is lower than a second priority of the configured grant; and determing whether to resume the first type data uploading after the end of the second type data uploading.

In one embodiment of the disclosure, the first message instructs the UE to resume the first type data uploading after the end of the second type data uploading if the first priority of the dynamic grant is lower than the second priority of the configured grant.

In one embodiment of the disclosure, the first message includes a modulation and coding scheme. The step of using the dynamic grant to upload the first type data according to the first message includes: uploading the first type data by using the modulation and coding scheme if determining to resume the first type data uploading after the end of the second type data uploading.

In one embodiment of the disclosure, the first message includes an index. The step of using the dynamic grant to upload the first type data according to the first message includes: selecting a modulation and coding scheme from a table comprising a plurality of modulation and coding schemes according to the index; and uploading the first type data by using the modulation and coding scheme if determining to resume the first type data uploading after the end of the second type data uploading.

In one embodiment of the disclosure, the method further includes: receiving a third message, wherein the third message includes an overlap threshold value; in response to that a ratio of an overlapping period between the first type data uploading and the second type data uploading to a period of the first type data uploading is greater than the overlap threshold value, not resuming the first type data uploading after the end of the second type data uploading; and in response to that the ratio is less than or equal to the overlap threshold value, resuming the first type data uploading after the end of the second type data uploading.

In one embodiment of the disclosure, the third message is a radio resource control signaling.

A method for uplink data transmission of the disclosure is suitable for a base station. The method includes: transmitting a first message to a UE, wherein the first message includes a dynamic grant which is used to upload a first type data; transmitting a second message to the UE, wherein the second message includes a configured grant which is used to upload a second type data; receiving the second type data; and in response to the reception of the second type data, determining whether to receive the first type data if the first type data uploading and the second type data uploading are partially or fully overlapping in time and a first priority of the dynamic grant is lower than a second priority of the configured grant.

In one embodiment of the disclosure, the method further includes: receiving the first type data if the reception of the second type data is failed.

In one embodiment of the disclosure, the method further includes: receiving the first type data if the reception of the second type data is successful and the first message instructs the UE to resume the first type data uploading after the end of the second type data uploading.

In one embodiment of the disclosure, the method further includes: not receiving the first type data if the reception of the second type data is successful and the first message instructs the UE to not resume the first type data uploading after the end of the second type data uploading.

In one embodiment of the disclosure, the first message includes a modulation and coding scheme. The step of receiving the first type data includes: decoding the first type data according to the modulation and coding scheme; and decoding the first type data according to a original modulation and coding scheme if the decoding according to the modulation and coding scheme is failed. In one embodiment of the disclosure, the first message includes an index. The step of receiving the first type data includes: selecting a modulation and coding scheme corresponding to the index from a table including a plurality of modulation and coding schemes; decoding the first type data according to the modulation and coding scheme; and decoding the first type data according to a original modulation and coding scheme if the decoding according to the modulation and coding scheme is failed.

In one embodiment of the disclosure, the method further includes: transmitting a third message, wherein the third message comprises an overlap threshold value.

In one embodiment of the disclosure, the method further includes: receiving the first type data in response to that a ratio of an overlapping period between the first type data uploading and the second type data uploading to a period of the first type data uploading is less than or equal to the overlap threshold value; and not receiving the first type data in response to that the ratio is greater than the overlap threshold value.

UE of the disclosure includes a processor and a transceiver. The processor is coupled to the transceiver, and is configured to perform actions: receiving a first message through the transceiver to obtain a dynamic grant; using the dynamic grant to upload a first type data according to the first message through the transceiver; receiving a second message through the transceiver to obtain a configured grant; using the configured grant to upload a second type data according to the second message through the transceiver; cancelling the first type data uploading if the first type data uploading and the second type data uploading are partially or fully overlapping in time and a first priority of the dynamic grant is lower than a second priority of the configured grant; and determining whether to resume the first type data uploading after the end of the second type data uploading.

A base station of the disclosure includes a processor and a transceiver. The processor is coupled to the transceiver, and is configured to perform actions: transmitting a first message to UE through the transceiver, wherein the first message includes a dynamic grant which is used to upload a first type data; transmitting a second message to the UE through the transceiver, wherein the second message includes a configured grant which is used to upload a second type data; receiving the second type data through the transceiver; and in response to the reception of the second type data, determining whether to receive the first type data if the first type data uploading and the second type data uploading are partially or fully overlapping in time and a first priority of the dynamic grant is lower than a second priority of the configured grant.

Based on the above, in conclusion, when a conflict occurs in the resources of two types of uplink data, the UE of the disclosure may drop one of the two types of uplink data according to the instruction of the base station, or puncture the other type of uplink data by one type of uplink data.

### BRIEF DESCRIPTION OF THE DRAWINGS

FIG. 1 illustrates a schematic diagram of transmitting enhanced mobile broadband (eMBB) data and ultra-reliable and low latency communications (URLLC) data by UE.

FIG. 2 illustrates a schematic diagram of uploading a second type data by using a method for dropping a first type data according to the embodiment of the disclosure.

FIG. 3 illustrates a schematic diagram of uploading a second type data by using a puncturing method according to the embodiment of the disclosure.

FIG. 4 illustrates a signaling diagram of uploading a second type data by using a method for dropping a first type data according to the embodiment of the disclosure.

FIG. 5 illustrates a flow diagram of the method as shown in FIG. 4, which is implemented by a base station, according to the embodiment of the disclosure.

FIG. 6 illustrates a flow diagram of the method as shown in FIG. 4, which is implemented by UE, according to the embodiment of the disclosure.

FIG. 7 illustrates a signaling diagram of uploading a second type data by puncturing a first type data according to the embodiment of the disclosure.

FIG. 8 illustrates a flow diagram of the method as shown in FIG. 7, which is implemented by a base station, according to the embodiment of the disclosure.

FIG. 9 illustrates a flow diagram of the method as shown in FIG. 7, which is implemented by UE, according to the embodiment of the disclosure.

FIG. 10 illustrates a signaling diagram of uploading a second type data by puncturing a first type data according to another embodiment of the disclosure.

FIG. 11 illustrates a flow diagram of the method as shown in FIG. 10, which is implemented by a base station, according to the embodiment of the disclosure.

FIG. 12 illustrates a flow diagram of the method as shown in FIG. 10, which is implemented by UE, according to the embodiment of the disclosure.

FIG. 13 illustrates a signaling diagram of uploading a second type data by puncturing a first type data according to a further embodiment of the disclosure.

FIG. 14 illustrates a flow diagram of the method as shown in FIG. 13, which is implemented by a base station, according to the embodiment of the disclosure.

FIG. 15 illustrates a flow diagram of the method as shown in FIG. 13, which is implemented by UE, according to the embodiment of the disclosure.

FIG. 16 illustrates a schematic diagram of a base station according to the embodiment of the disclosure.

FIG. 17 illustrates a flow diagram of a method for uplink data transmission, which is suitable for a base station, according to the embodiment of the disclosure.

FIG. 18 illustrates a schematic diagram of UE according to the embodiment of the disclosure.

FIG. 19 illustrates a flow diagram of a method for uplink data transmission, which is suitable for UE, according to the embodiment of the disclosure.

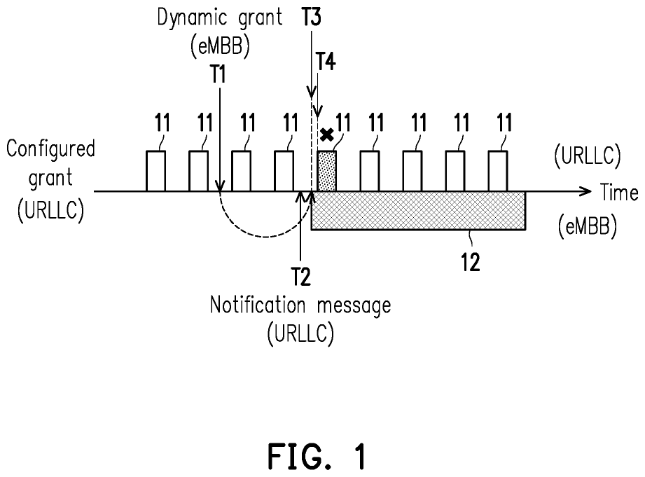

### DETAILED DESCRIPTION OF DISCLOSED EMBODIMENTS

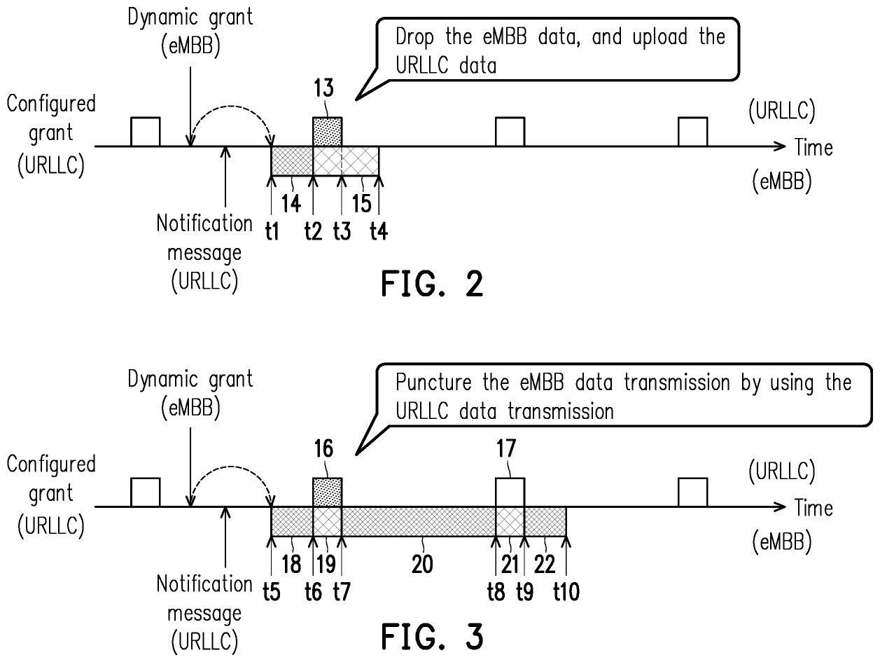

FIG. 2 illustrates a schematic diagram of uploading a second type data by using a method for dropping a first type data according to the embodiment of the disclosure. In this disclosure, it is assumed that the first type data is an enhanced mobile broadband (eMBB) data and the second type data is an ultra-reliable and low latency communications (URLLC) data, but this disclosure is not limited thereto. UE may implement the method as shown in FIG. 2 through a physical layer (PHY) or a media access control (MAC) layer.

If the UE receives a dynamic grant for instructing the UE to upload the eMBB data at a time point t1 and receives a notification message for instructing the UE to upload the URLLC data, and resources (i.e., a resource 14 started at the time point t1 and ended at a time point t2 and a resource 15 started at the time point t2 and ended at a time point t4) for uploading the eMBB data and a resource 13 (i.e., an uplink resource started at the time point t2 and ended at a time point t3) for uploading the URLLC data overlap in time, the UE may firstly upload the eMBB data by using the resource 14 at the time point t1 according to an instruction of a base station, and cancel uploading the eMBB data and start uploading the URLLC data at the time point t2. The uplink resource 15 of the eMBB data after the time point t2 will be dropped by the UE. In other words, the UE will not use the resource 15 to upload the eMBB data.

After the UE completes the uploading of the URLLC data at the time point t3, a portion of the resource 15 between the time point t3 and the time point t4 will be released. Therefore, the base station may reschedule the uplink resources between the time point t3 and the time point t4. For example, the base station may instruct the UE to use the uplink resources between the time point t3 and the time point t4 to upload a third type data to the base station. The third type data is, for example, the eMBB data or the URLLC data, but this disclosure is not limited to thereto.

FIG. 3 illustrates a schematic diagram of uploading the second type data by using a puncturing method according to the embodiment of the disclosure. In the present embodiment, the UE may puncture eMBB data transmission by using URLLC data transmission. The UE may implement the method as shown in FIG. 3 through a physical layer (PHY).

Specifically, if the UE receives a dynamic grant for instructing the UE to start uploading the eMBB data at a time point t5 and a notification message for instructing the UE to upload the URLLC data, and resources (i.e., a resource 18 started at the time point t5 and ended at a time point t6, a resource 19 started at the time point t6 and ended at a time point t7, a resource 20 started at the time point t7 and ended at a time point t8, a resource 21 started at the time point t8 and ended at a time point t9, and a resource 22 started at the time point t9 and ended at a time point t10) for uploading the eMBB data overlap in time a resource 16 (i.e., an uplink resource started at the time point t6 and ended at the time point t7) and a resource 17 (i.e., an uplink resource started at the time point t8 and ended at the time point t9) for uploading the URLLC data, the UE may firstly upload the eMBB data by using the resource 18 at the time point t5 according to an instruction of the base station, and stop uploading the eMBB data and start uploading the URLLC data at the time point t6. After the UE completes the uploading at the first stage of the URLLC data by using the resource 16 at the time point t7, the UE may resume uploading the eMBB data by using the resource 20. The eMBB data originally uploaded by using the resource 19 will be dropped by the UE. Similarly, the UE may stop uploading the eMBB data and start uploading the URLLC data at the time point t8 according to the instruction of the base station. After the UE completes the uploading at the second stage of the URLLC data by using the resource 17 at the time point t9, the UE may resume uploading the eMBB data by using the resource 22. The eMBB data originally uploaded by using the resource 21 may be dropped by the UE.

The above method may enable the UE to complete the uploading of the eMBB data and the URLLC data in an upload period (i.e., from the time point t5 to the time point t10) of the eMBB data.

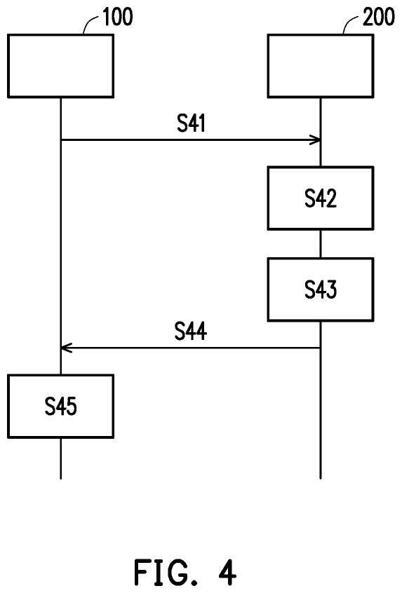

FIG. 4 illustrates a signaling diagram of uploading the second type data (such as: the URLLC data) by using a method for dropping the first type data (such as: the eMBB data) according to the embodiment of the disclosure. At step S41, the base station 100 may transmit a first message to the UE 200. The first message may include downlink control information (DCI) that may instruct the UE 200 to drop the eMBB data at a first time point of starting uploading the URLLC data. The first message is, for example, a dynamic grant of the eMBB data. The dynamic grant may be configured to instruct an upload period for uploading the eMBB data by the UE 200. The UE 200 may obtain the upload period for uploading the eMBB according to the dynamic grant. FIG. 2 is taken as an example. The UE 200 may obtain the resources (i.e., the resource 14 and the resource 15) between the time point t1 and the time point t4 according to the dynamic grant to upload the eMBB data.

In one embodiment, the dynamic grant may further include a modulation and coding scheme (MCS). The base station 100 may instruct the UE 200 to upload the data according to the MCS determined by the base station 100 by means of the dynamic grant.

At step S42, after obtaining the upload period of the eMBB data, the UE 200 may upload the eMBB data according to the upload period. The uploading may include steps that a transmission block (TB) of the eMBB data is established, the established TB is transmitted to the base station 100 (not shown in FIG. 4), and the like. The base station 100 may receive the eMBB data from the UE 200 in the upload period of the eMBB data. Specifically, the base station 100 may receive the data from the UE 200 in the upload period, and decode the received data according to a decoding algorithm for decoding the eMBB data.

In one embodiment, the UE 200 may transmit the TB of the eMBB data to the base station 100 through a physical uplink shared channel (PUSCH).

At step S43, if the UE 200 had received a second message for instructing the UE 200 to upload the URLLC data in the upload period of the eMBB data, the UE 200 may drop the eMBB data (i.e., cancel uploading the eMBB data) in the upload period of the eMBB data when starting uploading the URLLC data (including the step that the TB of the URLLC data is established) by using a pre-allocated resource of the URLLC data. The second message is, for example, a configuration message for instructing the UE 200 to upload the URLLC data, and the source of the configuration message is, for example, the base station 100. The disclosure is not limited thereto. FIG. 2 is taken as an example. When the pre-allocated resource 13 of the URLLC data reaches at the time point t2, the UE 200 may cancel uploading the eMBB data and start uploading the URLLC data by using the resource 13. The portion (i.e., the eMBB data needing to be uploaded by using the resource 15) of the eMBB data after the time point t2 will be dropped by the UE 200.

At step S44, the UE 200 may upload the TB of the URLLC data to the base station 100 through the PUSCH. FIG. 2 is taken as an example. The UE 200 may upload the TB of the URLLC data to the base station 100 through the PUSCH between the time point t2 and the time point t3.

At step S45, the base station 100 may determine whether the data received from the UE 200 includes the TB of the URLLC data. Specifically, the base station 100 may receive the second type data; and in response to the reception of the second type data, determine whether to receive the first type data. If the base station 100 determines that the received data includes the TB of the URLLC data, the base station 100 may cancel receiving the eMBB data. In one embodiment, if the base station 100 completes the receiving of the URLLC data in the upload period of the eMBB data, the base station 100 may reschedule the remaining uplink resources in the upload period. FIG. 2 is taken as an example. If the base station 100 completes the receiving of the URLLC data at the time point t3, the base station 100 may transmit a message to the UE 200 after the time point t3 to instruct the UE 200 to start uploading a third type data between the time point t3 and the time point t4. The third type data is, for example, the eMBB data or the URLLC data, but this disclosure is not limited thereto. Correspondingly, the base station 100 also needs to decode the uplink data from the UE 200 with a decoding algorithm corresponding to the third type data between the time point t3 and the time point t4.

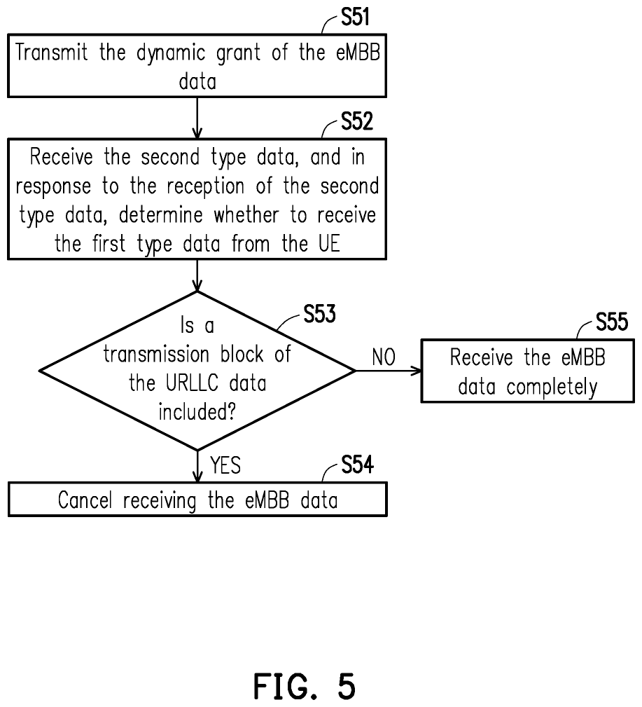

FIG. 5 illustrates a flow diagram of the method as shown in FIG. 4, which is implemented by the base station 100, according to the embodiment of the disclosure. At step S51, the base station 100 may transmit the dynamic grant of the eMBB data to the UE 200. The dynamic grant may be configured to instruct the UE 200 to drop the eMBB data when starting uploading the URLLC data.

At step S52, the base station 100 may receive the second type data; and in response to the reception of the second type data, determine whether to receive the first type data from the UE 200.

At step S53, the base station 100 may determine whether the data received from the UE 200 includes the TB of the URLLC data. If the data includes the TB of the URLLC data, step S54 proceeds. If the data does not include the TB of the URLLC data, step S55 proceeds.

At step S54, the base station 100 may cancel receiving the eMBB data. In one embodiment, the base station 100 may reschedule the remaining uplink resources originally used for uploading the eMBB data after completing the receiving of the URLLC data.

At step S55, the base station 100 may receive the eMBB data completely.

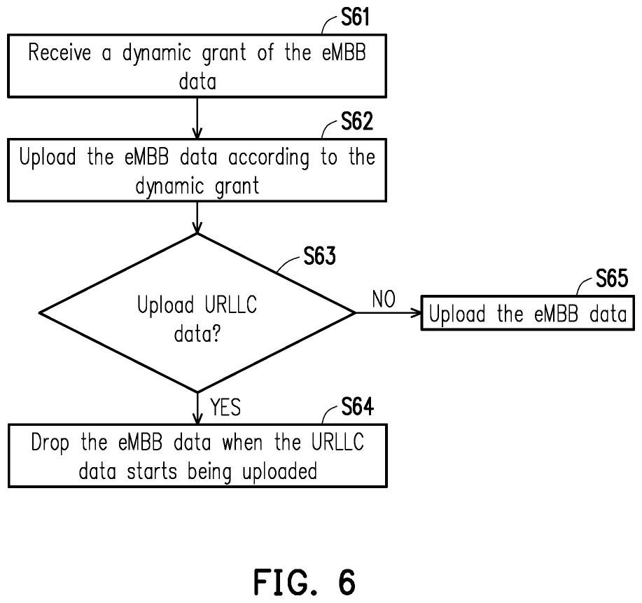

FIG. 6 illustrates a flow diagram of the method as shown in FIG. 4, which is implemented by the UE 200, according to the embodiment of the disclosure. At step S61, the UE 200 may receive the dynamic grant of the eMBB data from the base station 100. The dynamic grant may be configured to instruct the UE 200 to drop the eMBB data when starting uploading the URLLC data.

At step S62, the UE 200 may upload the eMBB data according to the dynamic grant. For example, the UE 200 may transmit the eMBB data to the base station 100 through the PUSCH.

At step S63, the UE 200 may determine whether the URLLC data needs to be uploaded in the upload period of the eMBB data. Specifically, if the UE 200 had received a notification message for instructing the UE 200 to upload the URLLC data, the UE 200 may determine whether the upload period of the URLLC data and the upload period of the eMBB data overlap in time. If the upload period of the URLLC data and the upload period of the eMBB data overlap in time, step S64 proceeds. If the UE 200 had not received the notification message for instructing the UE 200 to upload the URLLC data, or the upload period of the URLLC data and the upload period of the eMBB data do not overlap in time, step S65 proceeds.

At step S64, the UE 200 may drop the eMBB data when starting uploading the URLLC data (for example, through the PUSCH). In one embodiment, after the UE 200 completes the uploading of the URLLC data, the UE 200 may use the remaining uplink resources originally used for uploading the eMBB data according to the instruction of the base station 100.

At step S65, the UE 200 may upload the eMBB data in the upload period of the eMBB data.

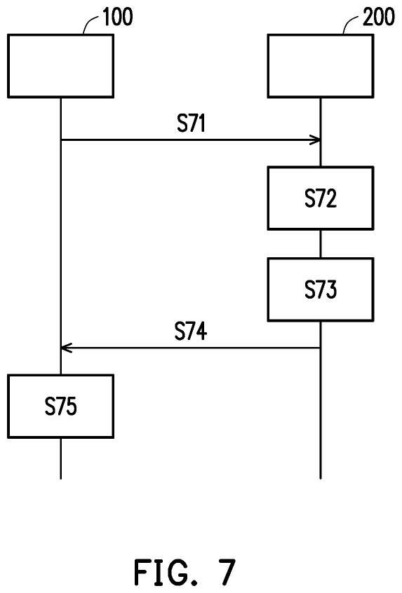

FIG. 7 illustrates a signaling diagram of uploading the second type data (such as: the URLLC data) by puncturing the first type data (such as: the eMBB data) according to the embodiment of the disclosure. At step S71, the base station 100 may transmit a first message to the UE 200. The first message may include DCI that instructs the UE 200 to upload the second type data by puncturing the first type data. The first message is, for example, a dynamic grant of the eMBB data. The dynamic grant may be configured to instruct an upload period of the UE 200 for uploading the eMBB data. The UE 200 may obtain the upload period for uploading the eMBB according to the dynamic grant. FIG. 3 is taken as an example. The UE 200 may obtain the resources (i.e., the resource 18, the resource 19, the resource 20, the resource 21, and the resource 22) between the time point t5 and the time point t10 according to the dynamic grant to upload the eMBB data.

The dynamic grant may further include a first MCS and a second MCS. In the present embodiment, the first MCS corresponds to a first number of bits, and the second MCS corresponds to a second number of bits. The first number is greater than or equal to the second number. For example, if the first MCS corresponds to 64 quadrature amplitude modulation (QAM), the second MCS may correspond to 16QAM or 8QAM. It is assumed that the UE 200 originally uses the first MCS to upload the eMBB data. If the UE 200 uploads the URLLC data by puncturing the eMBB data in the upload of the eMBB data, the uplink resources for uploading the eMBB data will be reduced. Therefore, the UE 200 may upload the eMBB data through the second MCS.

At step S72, after obtaining the upload period of the eMBB data, the UE 200 may upload the eMBB data according to the upload period. The uploading may include steps that a TB of the eMBB data is established, the established TB is transmitted to the base station 100 (not shown in FIG. 7), and the like. The UE 200 may upload the eMBB data according to one of the MCS. The base station 100 may receive the eMBB data from the UE 200 in the upload period of the eMBB data. Specifically, the base station 100 may receive the data from the UE 200 in the upload period, and decode the received data according to a decoding algorithm for decoding the eMBB data. FIG. 3 is taken as an example. The UE 200 may upload the eMBB data through the first MCS at the time point t5. The base station 100 may receive the eMBB data at the time point t5.

In one embodiment, the UE 200 may transmit the TB of the eMBB data to the base station 100 through the PUSCH.

At step S73, if the UE 200 had received a second message for instructing the UE 200 to upload the URLLC data in the upload period of the eMBB data, the UE 200 may puncture the eMBB data to upload the URLLC data by using a pre-allocated resource of the URLLC data in the upload period of the eMBB data (including the step that the TB of the URLLC data is established). The second message is, for example, a configuration message for instructing the UE 200 to upload the URLLC data, and the source of the configuration message is, for example, the base station 100. The disclosure is not limited thereto. At step S74, the UE 200 may upload the TB of the URLLC data to the base station 100 through the PUSCH. FIG. 3 is taken as an example. When the pre-allocated resource 16 of the URLLC data reaches at the time point t6, the UE 200 may stop uploading the eMBB data and start uploading the URLLC data by using the resource 13. The base station 100 may receive the URLLC data at the time point t6. After the UE 200 completes the uploading of the URLLC data at the time point t7, the UE 200 may resume uploading the eMBB data by using the resource 20. The base station 100 may receive the eMBB data at the time point t7.

At step S75, the base station 100 may determine whether the data received from the UE 200 includes the TB of the URLLC data. Specifically, the base station 100 may receive the second type data; and in response to the reception of the second type data, determine whether to receive the first type data. If the base station 100 determines that the received data does not include the TB of the URLLC data, the base station 100 may continue to receive the eMBB data. If the base station 100 determines that the received data includes the TB of the URLLC data, the base station 100 may receive the eMBB data after completing the receiving of the URLLC data. FIG. 3 is taken as an example. After the base station 100 completes the receiving of the URLLC data at the time point t7, the UE 200 may resume uploading the eMBB data through one of the MCS. The base station 100 may decode the received data through the second MCS and the decoding algorithm for decoding eMBB data. The eMBB data between the time point t6 and the time point t7 may be punctured by the UE 200.

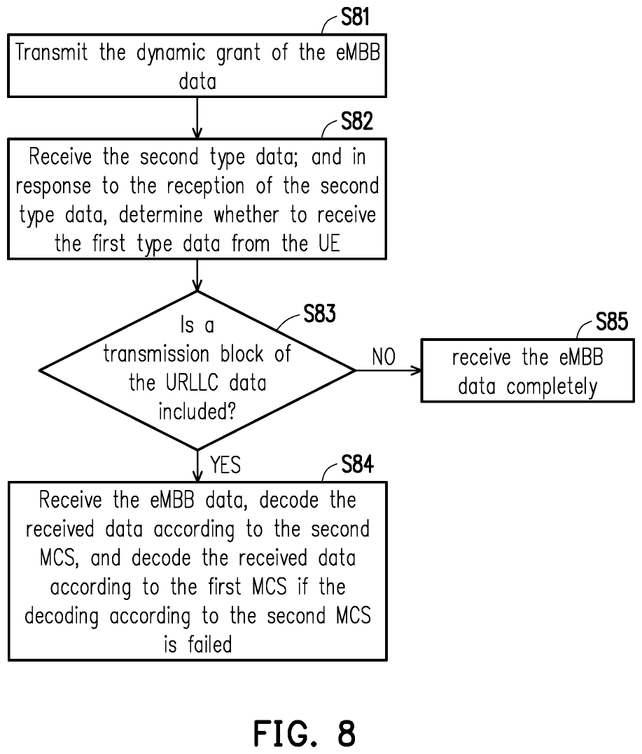

FIG. 8 illustrates a flow diagram of the method as shown in FIG. 7, which is implemented by the base station 100, according to the embodiment of the disclosure. At step S81, the base station 100 may transmit the dynamic grant of the eMBB data to the UE 200. The dynamic grant may be configured to instruct the UE 200 to upload the URLLC data by puncturing the eMBB data.

At step S82, the base station 100 may receive the second type data; and in response to the reception of the second type data, determine whether to receive the first type data from the UE 200.

At step S83, the base station 100 may determine whether the data received from the UE 200 includes the TB of the URLLC data. If the data includes the TB of the URLLC data, step S84 proceeds. If the data does not include the TB of the URLLC data, step S85 proceeds.

At step S84, the base station 100 may receive the eMBB data, decode the received data according to the second MCS, and decode the received data according to the first MCS if the decoding according to the second MCS is failed.

At step S85, the base station 100 may receive the eMBB data completely.

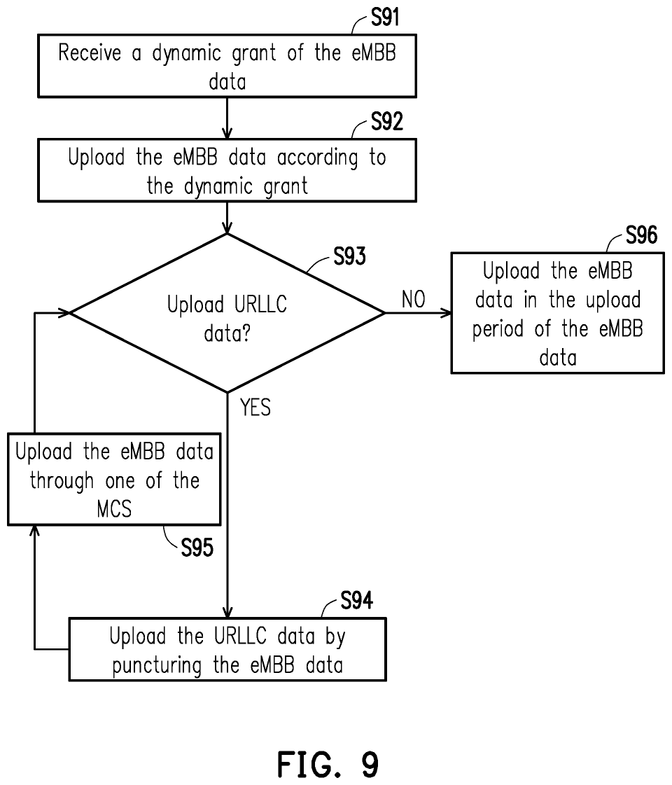

FIG. 9 illustrates a flow diagram of the method as shown in FIG. 7, which is implemented by the UE 200, according to the embodiment of the disclosure. At step S91, the UE 200 may receive the dynamic grant of the eMBB data from the base station 100. The dynamic grant may be configured to instruct the UE 200 to upload the URLLC data by puncturing the eMBB data. In addition, the dynamic grant may further include a first MCS and a second MCS.

At step S92, the UE 200 may upload the eMBB data according to the dynamic grant. For example, the UE 200 may transmit the eMBB data to the base station 100 through the PUSCH.

At step S93, the UE 200 may determine whether the URLLC data needs to be uploaded in the upload period of the eMBB data. Specifically, if the UE 200 had received a notification message for instructing the UE 200 to upload the URLLC data, the UE 200 may determine whether the upload period of the URLLC data and the upload period of the eMBB data overlap in time. If the upload period of the URLLC data and the upload period of the eMBB data overlap in time, step S94 proceeds. If the UE 200 had not received the notification message for instructing the UE 200 to upload the URLLC data, or the upload period of the URLLC data and the upload period of the eMBB data do not overlap in time, step S96 proceeds.

At step S94, the UE 200 may upload the URLLC data by puncturing the eMBB data.

At step S95, after completing the uploading of the URLLC data, the UE 200 may upload the eMBB data through one of the MCS. The UE 200 may transmit the eMBB data to the base station 100 through the PUSCH.

At step S96, the UE 200 may continue uploading the eMBB data in the upload period of the eMBB data.

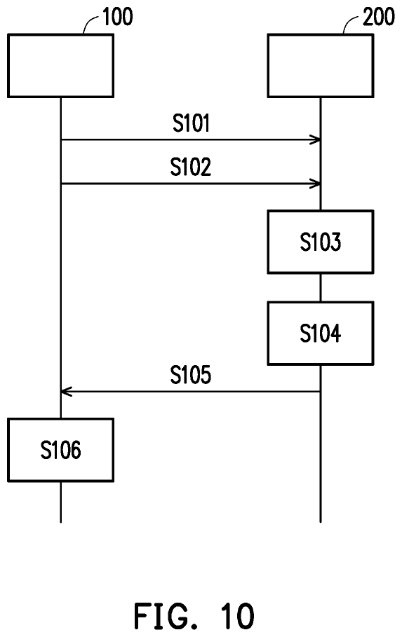

FIG. 10 illustrates a signaling diagram of uploading the second type data (such as: the URLLC data) by puncturing the first type data (such as: the eMBB data) according to another embodiment of the disclosure. At step S101, the base station 100 may transmit a radio resource control (RRC) signaling to the UE 200. The RRC signaling may include a table containing a plurality of MCSs. In one embodiment, the RRC signaling is, for example, an intra-UE-prioritization configuration.

At step S102, the base station 100 may transmit a first message to the UE 200. The first message may include DCI that instructs the UE 200 to upload the second type data by puncturing the first type data. The first message is, for example, a dynamic grant of the eMBB data. The dynamic grant may be configured to instruct an upload period of the UE 200 for uploading the eMBB data. The UE 200 may obtain the upload period for uploading the eMBB according to the dynamic grant. FIG. 3 is taken as an example. The UE 200 may obtain the resources (i.e., the resource 18, the resource 19, the resource 20, the resource 21, and the resource 22) between the time point t5 and the time point t10 according to the dynamic grant to upload the eMBB data.

The dynamic grant may further include a first MCS and a second index corresponding to the second MCS. In the present embodiment, the first MCS corresponds to a first number of bits, and the second index corresponds to a second number of bits. The first number is greater than the second number. For example, if the first MCS corresponds to 64QAM, the second MCS may correspond to 16QAM or 8QAM. It is assumed that the UE 200 originally uses the first MCS to upload the eMBB data. If the UE 200 uploads the URLLC data by puncturing the eMBB data in the upload of the eMBB data, the uplink resources for uploading the eMBB data will be reduced. Therefore, the UE 200 may upload the eMBB data through the second index corresponding to the second MCS.

At step S103, after obtaining the upload period of the eMBB data, the UE 200 may upload the eMBB data according to the upload period. The uploading may include steps that a TB of the eMBB data is established, the established TB is transmitted to the base station 100 (not shown in FIG. 10), and the like. The UE 200 may select the second MCS from the table containing the plurality of MCSs according to the second index, and may upload the eMBB data according to one of the MCS. The base station 100 may receive the eMBB data from the UE 200 in the upload period of the eMBB data. Specifically, the base station 100 may receive the data from the UE 200 in the upload period, and decode the received data according to a decoding algorithm for decoding the eMBB data. FIG. 3 is taken as an example. The UE 200 may upload the eMBB data through the first MCS at the time point t5. The base station 100 may receive the eMBB data at the time point t5.

In one embodiment, the UE 200 may transmit the TB of the eMBB data to the base station 100 through the PUSCH.

At step S104, if the UE 200 had received a second message for instructing the UE 200 to upload the URLLC data in the upload period of the eMBB data, the UE 200 may puncture the eMBB data to upload the URLLC data by using a pre-allocated resource of the URLLC data in the upload period of the eMBB data (including the step that the TB of the URLLC data is established). The second message is, for example, a configuration message for instructing the UE 200 to upload the URLLC data, and the source of the configuration message is, for example, the base station 100. The disclosure is not limited thereto. At step S105, the UE 200 may upload the TB of the URLLC data to the base station 100 through the PUSCH. FIG. 3 is taken as an example. When the pre-allocated resource 16 of the URLLC data reaches at the time point t6, the UE 200 may stop uploading the eMBB data and start uploading the URLLC data by using the resource 13. The base station 100 may receive the URLLC data at the time point t6. After the UE 200 completes the uploading of the URLLC data at the time point t7, the UE 200 may resume uploading the eMBB data by using the resource 20. The base station 100 may receive the eMBB data at the time point t7.

At step S106, the base station 100 may determine whether the data received from the UE 200 includes the TB of the URLLC data. Specifically, the base station 100 may receive the second type data; and in response to the reception of the second type data, determine whether to receive the first type data. If the base station 100 determines that the received data does not include the TB of the URLLC data, the base station 100 may continue to receive the eMBB data. If the base station 100 determines that the received data includes the TB of the URLLC data, the base station 100 may receive the eMBB data after completing the receiving of the URLLC data.

FIG. 3 is taken as an example. After the base station 100 completes the receiving of the URLLC data at the time point t7, the UE 200 may resume uploading the eMBB data through one of the MCS. The base station 100 may decode the received data through the second MCS and the decoding algorithm for decoding eMBB data at the time point t7. The eMBB data between the time point t6 and the time point t7 may be punctured by the UE 200.

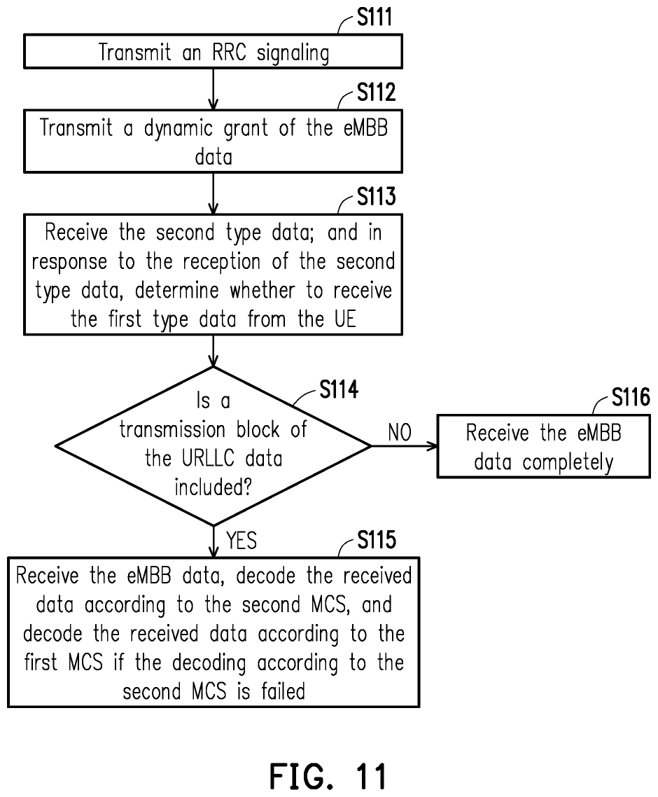

FIG. 11 illustrates a flow diagram of the method as shown in FIG. 10, which is implemented by the base station 100, according to the embodiment of the disclosure. At step S111, the base station 100 may transmit an RRC signaling to the UE 200. The RRC signaling may include a table containing a plurality of MCSs.

At step S112, the base station 100 may transmit the dynamic grant of the eMBB data to the UE 200. The dynamic grant may be configured to instruct the UE 200 to upload the URLLC data by puncturing the eMBB data, and the dynamic grant includes a first MCS and a second index corresponding to the second MCS.

At step S113, the base station 100 may receive the second type data; and in response to the reception of the second type data, determine whether to receive the first type data from the UE 200.

At step S114, the base station 100 may determine whether the data received from the UE 200 includes the TB of the URLLC data. If the data includes the TB of the URLLC data, step S115 proceeds. If the data does not include the TB of the URLLC data, step S116 proceeds.

At step S115, the base station 100 may receive the eMBB data, decode the received data according to the second MCS, and decode the received data according to the first MCS if the decoding according to the second MCS is failed.

At step S116, the base station 100 may receive the eMBB data completely.

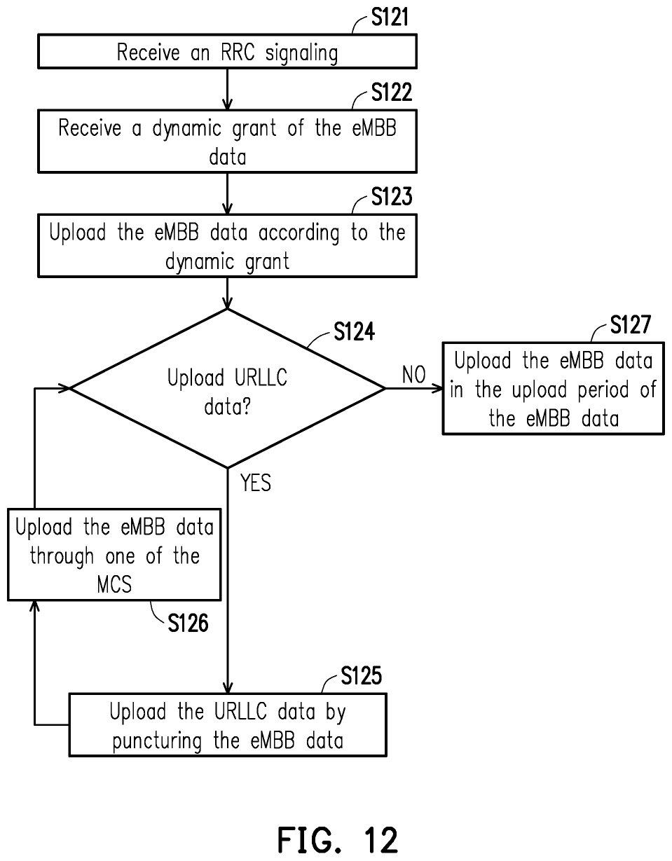

FIG. 12 illustrates a flow diagram of the method as shown in FIG. 10, which is implemented by the UE 200, according to the embodiment of the disclosure. At step S121, the UE 200 may receive an RRC signaling from the base station 100. The RRC signaling may include a table containing a plurality of MCSs.

At step S122, the UE 200 may receive the dynamic grant of the eMBB data from the base station 100. The dynamic grant may be configured to instruct the UE 200 to upload the URLLC data by puncturing the eMBB data. In addition, the dynamic grant may further include a first MCS and a second index corresponding to the second MCS.

At step S123, the UE 200 may upload the eMBB data according to the dynamic grant. Specifically, the UE 200 may select the second MCS from the table containing the plurality of MCSs according to the second index, and may upload the eMBB data according to the second MCS. The UE 200 may transmit the eMBB data to the base station 100 through the PUSCH.

At step S124, the UE 200 may determine whether the URLLC data needs to be uploaded in the upload period of the eMBB data. Specifically, if the UE 200 had received a notification message for instructing the UE 200 to upload the URLLC data, the UE 200 may determine whether the upload period of the URLLC data and the upload period of the eMBB data overlap in time. If the upload period of the URLLC data and the upload period of the eMBB data overlap in time, step S125 proceeds. If the UE 200 had not received the notification message for instructing the UE 200 to upload the URLLC data, or the upload period of the URLLC data and the upload period of the eMBB data do not overlap in time, step S127 proceeds.

At step S125, the UE 200 may upload the URLLC data by puncturing the eMBB data.

At step S126, after completing the uploading of the URLLC data, the UE 200 may upload the eMBB data through one of the MCS. Specifically, the UE 200 may select the second MCS from the table containing the plurality of MCSs according to the second index. The UE 200 may transmit the eMBB data to the base station 100 through the PUSCH.

At step S127, the UE 200 may continue uploading the eMBB data in the upload period of the eMBB data.

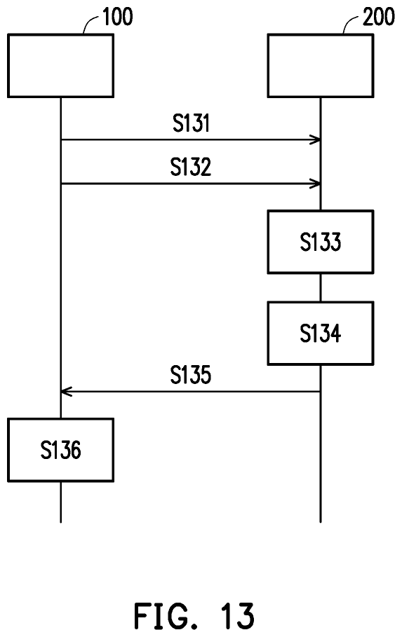

FIG. 13 illustrates a signaling diagram of uploading the second type data (such as: the URLLC data) by puncturing the first type data (such as: the eMBB data) according to a further embodiment of the disclosure. At step S131, the base station 100 may transmit an RRC signaling to the UE 200. The RRC signaling may include an overlap threshold value. In one embodiment, the RRC signaling is, for example, an intra-UE-prioritization configuration. In one embodiment, the RRC signaling may further include a second MCS.

At step S132, the base station 110 may transmit a first message to the UE 200. The first message is, for example, a dynamic grant of the eMBB data. The dynamic grant may be configured to instruct an upload period of the UE 200 for uploading the eMBB data. The UE 200 may obtain the upload period for uploading the eMBB according to the dynamic grant. FIG. 3 is taken as an example. The UE 200 may obtain the resources (i.e., the resource 18, the resource 19, the resource 20, the resource 21, and the resource 22) between the time point t5 and the time point t10 according to the dynamic grant to upload the eMBB data.

At step S133, after obtaining the upload period of the eMBB data, the UE 200 may upload the eMBB data according to the upload period. The uploading may include steps that a TB of the eMBB data is established, the established TB is transmitted to the base station 100 (not shown in FIG. 13), and the like. The UE 200 may upload the eMBB data according to one of the MCS. The base station 100 may receive the eMBB data from the UE 200 in the upload period of the eMBB data. Specifically, the base station 100 may receive the data from the UE 200 in the upload period, and decode the received data according to a decoding algorithm for decoding the eMBB data. FIG. 3 is taken as an example. The UE 200 may upload the eMBB data at the time point t5. The base station 100 may receive the eMBB data at the time point t5.

In one embodiment, the UE 200 may transmit the TB of the eMBB data to the base station 100 through the PUSCH.

At step S134, if the UE 200 had received a second message for instructing the UE 200 to upload the URLLC data in the upload period of the eMBB data, the UE 200 may determine whether to upload the URLLC data by puncturing the eMBB data or by dropping the eMBB data in the upload period of the eMBB data according to the overlap threshold value. The second message is, for example, a configuration message for instructing the UE 200 to upload the URLLC data, and the source of the configuration message is, for example, the base station 100. The disclosure is not limited thereto. At step S135, the UE 200 may upload the TB of the URLLC data to the base station 100 through the PUSCH.

Specifically, the UE 200 may calculate a ratio of an overlapping period between the eMBB data uploading and the URLLC data uploading to a period of the eMBB data uploading. If the ratio is greater than the overlap threshold value, the UE 200 uploads the URLLC data by dropping the eMBB data. FIG. 2 is taken as an example. When the pre-allocated resource 13 of the URLLC data reaches at the time point t2, the UE 200 may cancel uploading the eMBB data and start uploading the URLLC data by using the resource 13. The portion (i.e., the eMBB data needing to be uploaded by using the resource 15) of the eMBB data after the time point t2 will be dropped by the UE 200.

On the other hand, if the ratio is less than or equal to the overlap threshold value, the UE 200 uploads the URLLC data by puncturing the eMBB data. FIG. 3 is taken as an example. When the pre-allocated resource 16 of the URLLC data reaches at the time point t6, the UE 200 may stop uploading the eMBB data and start uploading the URLLC data by using the resource 13. The base station 100 may receive the URLLC data at the time point t6. After the UE 200 completes the uploading of the URLLC data at the time point t7, the UE 200 may resume uploading the eMBB data by using the resource 20. The base station 100 may receive the eMBB data at the time point t7.

At step S136, the base station 100 may determine whether the data received from the UE 200 includes the TB of the URLLC data. If the base station 100 determines that the received data includes the TB of the URLLC data, the base station 100 may further determine whether the ratio of an overlapping period between the eMBB data uploading and the URLLC data uploading to a period of the eMBB data uploading is greater than the overlap threshold value. If the ratio is greater than the overlap threshold value, the base station 100 may cancel receiving the eMBB data. If the ratio is less than or equal to the overlap threshold value, the base station 100 may receive the eMBB data after completing the receiving of the URLLC data. On the other hand, if the base station 100 determines that the received data does not include the TB of the URLLC data, the base station 100 may receive the eMBB data completely.

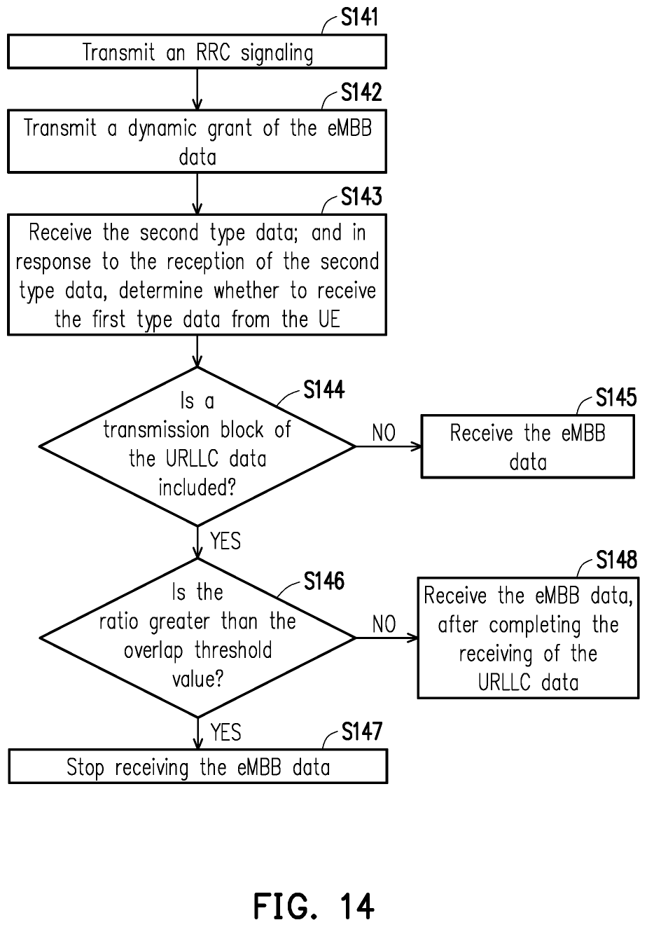

FIG. 14 illustrates a flow diagram of the method as shown in FIG. 13, which is implemented by the base station 100, according to the embodiment of the disclosure. At step S141, the base station 100 may transmit an RRC signaling to the UE 200. The RRC signaling may include an overlap threshold value. In one embodiment, the RRC signaling may further include a second MCS.

At step S142, the base station 100 may transmit the dynamic grant of the eMBB data to the UE 200. The dynamic grant may include a first MCS.

At step S143, the base station 100 may receive the second type data; and in response to the reception of the second type data, determine whether to receive the first type data from the UE 200.

At step S144, the base station 100 may determine whether the data received from the UE 200 includes the TB of the URLLC data. If the data includes the TB of the URLLC data, step S146 proceeds. If the data does not include the TB of the URLLC data, step S145 proceeds.

At step S145, the base station 100 may receive the eMBB data.

At step S146, the base station 100 may determine whether a ratio of an overlapping period between the eMBB data uploading and the URLLC data uploading to a period of the eMBB data uploading is greater than the overlap threshold value according to the received data. If the ratio is greater than the overlap threshold value, step S147 proceeds. If the ratio is less than or equal to the overlap threshold value, step S148 proceeds.

At step S147, the base station 100 may stop receiving the eMBB data.

At step S148, the base station 100 may receive the eMBB data, after completing the receiving of the URLLC data.

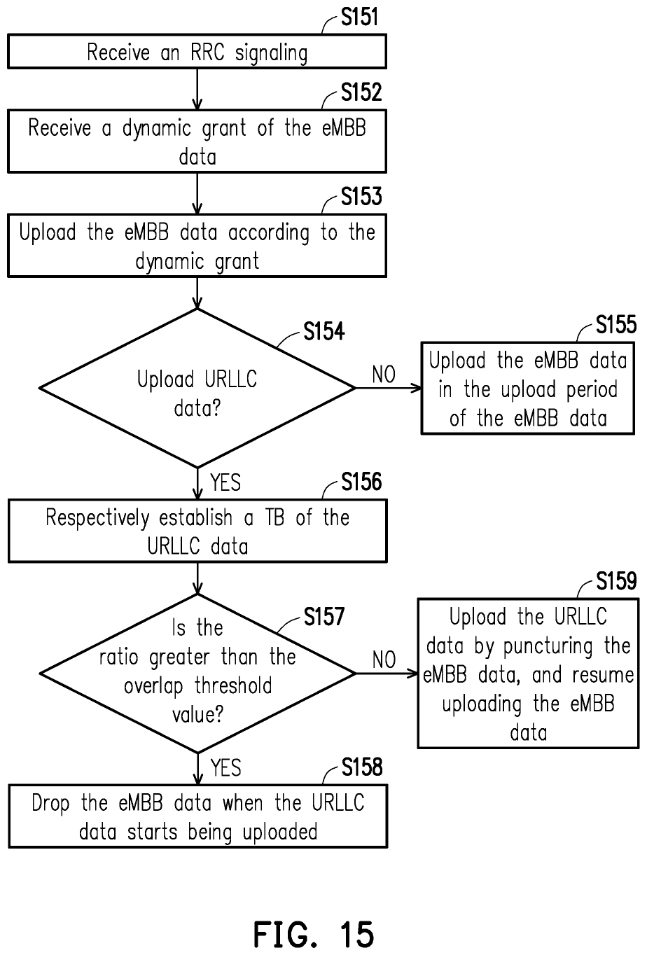

FIG. 15 illustrates a flow diagram of the method as shown in FIG. 13, which is implemented by UE, according to the embodiment of the disclosure. At step S151, the UE 200 may receive an RRC signaling from the base station 100. The RRC signaling may include an overlap threshold value. In one embodiment, the RRC signaling may further include a second MCS.

At step S152, the UE 200 may receive the dynamic grant of the eMBB data from the base station 100. The dynamic grant may include a first MCS.

At step S153, the UE 200 may upload the eMBB data according to the dynamic grant. The UE 200 may transmit the eMBB data to the base station 100 through the PUSCH.

At step S154, the UE 200 may determine whether the URLLC data needs to be uploaded in the upload period of the eMBB data. Specifically, if the UE 200 had received a notification message for instructing the UE 200 to upload the URLLC data, the UE 200 may determine whether the upload period of the URLLC data and the upload period of the eMBB data overlap in time. If the upload period of the URLLC data and the upload period of the eMBB data overlap in time, step S156 proceeds. If the UE 200 had not received the notification message for instructing the UE 200 to upload the URLLC data, or the upload period of the URLLC data and the upload period of the eMBB data do not overlap in time, step S155 proceeds.

At step S155, the UE 200 may continue to upload the eMBB data in the upload period of the eMBB data.

At step S156, the UE 200 may respectively establish a TB of the URLLC data.

At step S157, the UE 200 may determine whether a ratio of an overlapping period between the eMBB data uploading and the URLLC data uploading to a period of the eMBB data uploading is greater than the overlap threshold value according to the TB of the URLLC data and the TB of the eMBB data. If the ratio is greater than the overlap threshold value, step S158 proceeds. If the ratio is less than or equal to the overlap threshold value, step S159 proceeds.

At step S158, the UE 200 may drop the eMBB data when starting uploading the URLLC data (for example, through the PUSCH).

At step S159, the UE 200 may upload the URLLC data by puncturing the eMBB data. After completing the uploading of the URLLC data, the UE 200 may resume uploading the eMBB data.

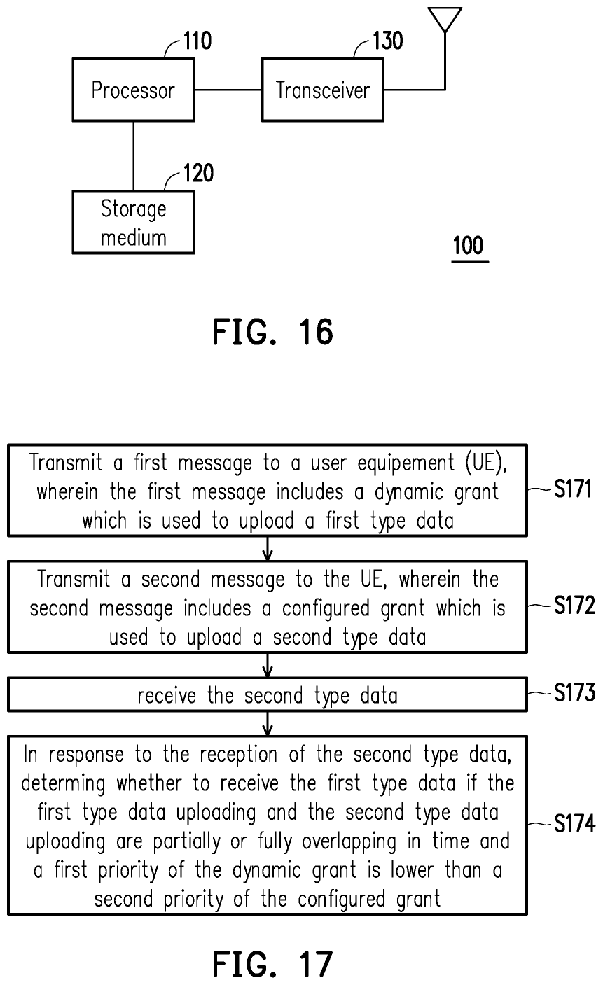

FIG. 16 illustrates a schematic diagram of a base station 100 according to the embodiment of the disclosure. The base station 100 may include a processor 110, a storage medium 120, and a transceiver 130.

The processor 110 is, for example, a central processing unit (CPU), or other programmable general-purpose or special-purpose micro control units (MCUs), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA) or other similar elements or a combination of the above elements. The processor 110 may be coupled to the storage medium 120 and the transceiver 130, and may access and execute multiple modules and various applications stored in the storage medium 120.

The storage medium 120 is, for example, any type of fixed or mobile random access memory (RAM), read-only memory (ROM), flash memory, hard disk drive (HDD), solid state drive (SSD) or similar elements or a combination of the above elements, and is used to store multiple modules or various applications that can be executed by the processor 110.

The transceiver 130 transmits and receives signals in a wireless or wired manner. The transceiver 130 may also perform low noise amplification, impedance matching, frequency mixing, up or down frequency conversion, filtering, amplification, and similar operations. The transceiver 130 may further include an antenna array, which may include one or more antennas for transmitting and receiving an omnidirectional antenna beam or a directional antenna beam.

FIG. 17 illustrates a flow diagram of a method for uplink data transmission, which is suitable for the base station 100, according to the embodiment of the disclosure. The processor 110 of the base station 100 may be configured to perform the steps described below. At step S171, transmitting a first message through the transceiver to a UE. The first message includes a dynamic grant which is used to upload a first type data. At step S172, transmitting a second message through the transceiver to the UE. The second message includes a configured grant which is used to upload a second type data. At step S173, receiving the second type data through the transceiver. At step S174, in response to the reception of the second type data, determining whether to receive the first type data if the first type data uploading and the second type data uploading are partially of fully overlapping in time and a first priority of the dynamic grant is lower than a second priority of the configured grants.

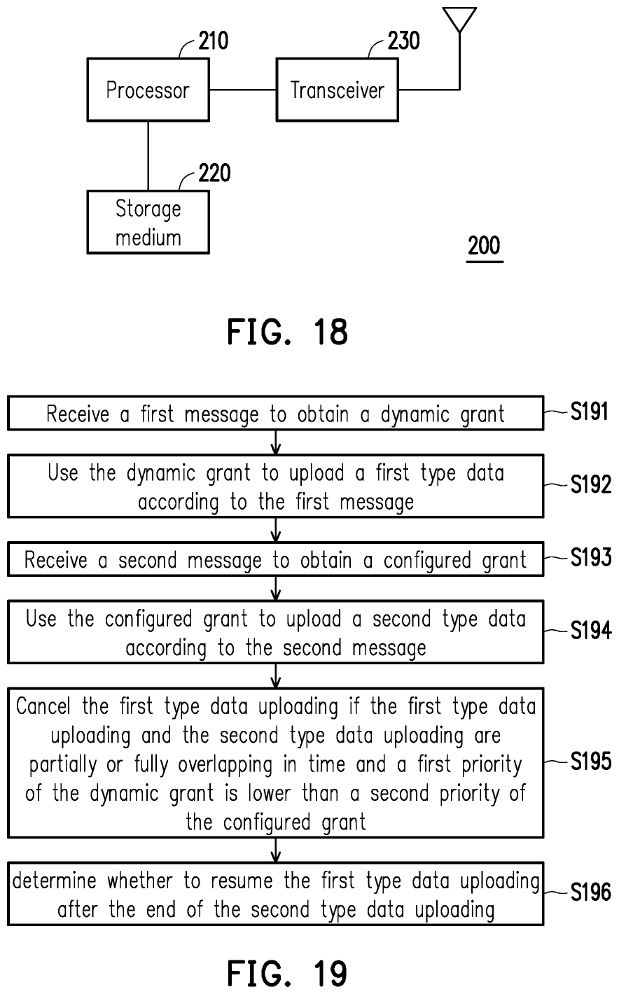

FIG. 18 illustrates a schematic diagram of UE 200 according to the embodiment of the disclosure. The UE 200 may include a processor 210, a storage medium 220, and a transceiver 230.

The processor 210 is, for example, a CPU, or other programmable general-purpose or special-purpose MCUs, a microprocessor, a DSP, a programmable controller, an ASIC, a GPU, an ISP, an IPU, an ALU, a CPLD, an FPGA or other similar elements or a combination of the above elements. The processor 210 may be coupled to the storage medium 220 and the transceiver 230, and may access and execute multiple modules and various applications stored in the storage medium 220.

The storage medium 220 is, for example, any type of fixed or mobile RAM, ROM, flash memory, HDD, SSD or similar elements or a combination of the above elements, and is used to store multiple modules or various applications that can be executed by the processor 210.

The transceiver 230 transmits and receives signals in a wireless or wired manner. The transceiver 230 may also perform low noise amplification, impedance matching, frequency mixing, up or down frequency conversion, filtering, amplification, and similar operations. The transceiver 230 may further include an antenna array, which may include one or more antennas for transmitting and receiving an omnidirectional antenna beam or a directional antenna beam.

FIG. 19 illustrates a flow diagram of a method for uplink data transmission, which is suitable for the UE 200, according to the embodiment of the disclosure. The processor 210 of the base station 200 may be configured to perform the steps described below. At step S191, receiving a first message through the transceiver to obtain a dynamic grant. At step S192, using the dynamic grant to upload a first type data according to the first message. At step S193, receiving a second message through the transceiver to obtain a configured grant. At step S194, using the configured grant to upload a second type data according to the second message. At step S195, cancelling the first type data uploading if the first type data uploading and the second type data uploading are partially or fully overlapping in time and a first priority of the dynamic grant is lower than a second priority of the configured grant. At step S196, determining whether to resume the first type data uploading after the end of the second type data uploading.

Based on the above, when a conflict occurs in the resources of two types of uplink data, the UE of the disclosure may drop one of the two types of uplink data, or puncture one type of uplink data by the other one type of uplink data according to the instruction of the base station. If the base station instructs the UE to drop the first type data and upload the second type data, the base station may reschedule the resources originally used to transmit the first type data after the uploading of the second type data is completed. If the base station instructs the UE to resume uploading the first type data, and upload the second type data in a puncturing manner during the uploading of the first type data, the UE may upload the first type data based on the modulation and coding scheme according to the instruction of the base station. In another aspect, the UE may also determine whether to use a dropping scheme or a puncturing scheme to transmit uplink data according to the ratio of an overlapping period between the first type data uploading and the second type data uploading to a period of the first type data uploading. In this way, when the conflict occurs in the resources of the uplink data, the UE may use these resources in the most efficient way.

What is claimed is:

1. A method for uplink data transmission, suitable for user equipment (UE), the method comprising:
receiving a first message to obtain a dynamic grant;
using the dynamic grant to upload a first type data according to the first message;
receiving a second message to obtain a configured grant;
using the configured grant to upload a second type data according to the second message;
cancelling the first type data uploading if the first type data uploading and the second type data uploading are partially or fully overlapping in time and a first priority of the dynamic grant is lower than a second priority of the configured grant; and
determining whether to resume the first type data uploading after the end of the second type data uploading.

2. The method according to claim 1, wherein the first message instructs the UE to resume the first type data uploading after the end of the second type data uploading if the first priority of the dynamic grant is lower than the second priority of the configured grant.

3. The method according to claim 1, wherein the first message comprises a modulation and coding scheme; and the step of using the dynamic grant to upload the first type data according to the first message comprises:
uploading the first type data by using the modulation and coding scheme if determing to resume the first type data uploading after the end of the second type data uploading.

4. The method according to claim 1, wherein the first message comprises an index; and the step of using the dynamic grant to upload the first type data according to the first message comprises:
selecting a modulation and coding scheme from a table comprising a plurality of modulation and coding schemes according to the index; and
uploading the first type data by using the modulation and coding scheme if determining to resume the first type data uploading after the end of the second type data uploading.

5. The method according to claim 1, further comprising:
receiving a third message, wherein the third message comprises an overlap threshold value;
in response to that a ratio of an overlapping period between the first type data uploading and the second type data uploading to a period of the first type data uploading is greater than the overlap threshold value, not resuming the first type data uploading after the end of the second type data uploading; and
in response to that the ratio is less than or equal to the overlap threshold value, resuming the first type data uploading after the end of the second type data uploading.

6. The method according to claim 5, wherein the third message is a radio resource control signaling.

7. A method for uplink data transmission, suitable for a base station, the method comprising:
transmitting a first message to a user equipment (UE), wherein the first message includes a dynamic grant which is used to upload a first type data;
transmitting a second message to the UE, wherein the second message includes a configured grant which is used to upload a second type data;
receiving the second type data; and
in response to the reception of the second type data, determing whether to receive the first type data if the first type data uploading and the second type data uploading are partially or fully overlapping in time and a first priority of the dynamic grant is lower than a second priority of the configured grant.

8. The method according to claim 7, further comprising:
receiving the first type data if the reception of the second type data is failed.

9. The method according to claim 7, further comprising:
receiving the first type data if the reception of the second type data is successful and the first message instructs the UE to resume the first type data uploading after the end of the second type data uploading.

10. The method according to claim 7, further comprising:
not receiving the first type data if the reception of the second type data is successful and the first message instructs the UE to not resume the first type data uploading after the end of the second type data uploading.

11. The method according to claim 9, wherein the first message comprises a modulation and coding scheme; and the step of receiving the first type data comprises:
decoding the first type data according to the modulation and coding scheme; and
decoding the first type data according to a original modulation and coding scheme if the decoding according to the modulation and coding scheme is failed.

12. The method according to claim 9, wherein the first message comprises an index; and the step of receiving the first type data comprises:
selecting a modulation and coding scheme corresponding to the index from a table comprising a plurality of modulation and coding schemes;
decoding the first type data according to the modulation and coding scheme; and
decoding the first type data according to a original modulation and coding scheme if the decoding according to the modulation and coding scheme is failed.

13. The method according to claim 7, further comprising:
transmitting a third message, wherein the third message comprises an overlap threshold value.

14. The method according to claim 13, further comprises:
receiving the first type data in response to that a ratio of an overlapping period between the first type data uploading and the second type data uploading to a period of the first type data uploading is less than or equal to the overlap threshold value; and
not receiving the first type data in response to that the ratio is greater than the overlap threshold value.

15. User equipment (UE), comprising:
a transceiver; and
a processor, coupled to the transceiver, and configured to perform:
receiving a first message through the transceiver to obtain a dynamic grant;
using the dynamic grant to upload a first type data according to the first message through the transceiver;
receiving a second message through the transceiver to obtain a configured grant;
using the configured grant to upload a second type data according to the second message through the transceiver;
cancelling the first type data uploading if the first type data uploading and the second type data uploading are partially or fully overlapping in time and a first priority of the dynamic grant is lower than a second priority of the configured grant; and
determining whether to resume the first type data uploading after the end of the second type data uploading.

16. A base station, comprising:
a transceiver; and
a processor, coupled to the transceiver, and configured to perform:
transmitting a first message to a user equipment (UE) through the transceiver, wherein the first message includes a dynamic grant which is used to upload a first type data;
transmitting a second message to the UE through the transceiver, wherein the second message includes a configured grant which is used to upload a second type data;
receiving the second type data through the transceiver; and
in response to the reception of the second type data, determining whether to receive the first type data if the first type data uploading and the second type data uploading are partially or fully overlapping in time and a first priority of the dynamic grant is lower than a second priority of the configured grant.
